(19) United States
(12) Patent Application Publication
(10) Pub. No.: US 2020/0278959 A1
(43) Pub. Date: Sep. 3, 2020

(54) SYSTEM AND METHOD FOR BLOCKCHAIN COEXISTENCE

(71) Applicant: Tata Consultancy Services Limited, Mumbai (IN)

(72) Inventor: Vivekanand RAMGOPAL, Chennai (IN)

(73) Assignee: Tata Consultancy Services Limited, Mumbai (IN)

(21) Appl. No.: 16/759,022

(22) PCT Filed: Oct. 26, 2018
(86) PCT No.: PCT/IB2018/058384

§ 371 Date: Apr. 24, 2020

(30) Foreign Application Priority Data
Oct. 27, 2017 (IN) 201721038132

(51) Int. Cl. G06F 16/23; G06Q 10/10

(52) U.S. Cl. CPC G06F 16/2379; H04L 9/3247; G06Q 10/10

(57) ABSTRACT

This disclosure relates generally to a system and method for blockchain coexistence. The blockchain coexistence between a blockchain ecosystem and a non-blockchain ecosystem is enabled by a gateway which establishes communication between any existing system and the blockchain ecosystem. Herein, the system is used to connect a blockchain solution with at least one existing application by utilizing the gateway framework. The gateway framework includes a gateway and information on a set of smart solutions. The gateway incudes a simple Java APIs (Application Programming Interfaces) on one side for the existing systems or the traditional applications to connect to the distributed ledger application programming interface (DLAPI) on the other side for connecting with the different block chain technologies.

### PRIORITY

This application is a U.S. National Stage Filing under 35 U.S.C. § 371 and claims priority from International Application No. PCT/IB2018/058384, filed on Oct. 26, 2018, which claims priority under 35 U.S.C. § 119 from Indian Application No. 201721038132, filed on Oct. 27, 2017. The entire contents of the aforementioned applications are incorporated herein by reference.

### TECHNICAL FIELD

The present disclosure in general relates to data management, and more particularly to system and method for block chain coexistence.

### BACKGROUND

In the field of data management, a blockchain is a key technology for providing real-time processing, transparency and collaboration. The blockchain is an emerging field which provides faster, cheaper, more secure and transparent transactions. The blockchain is able to synchronize data across participating entities and encourages firms to collaborate. The blockchain is an asset database or a distributed ledger and can be shared across a network of multiple sites, geographies or institutions. Here, every user in the network may maintain an own identical copy of the ledger. Any changes made in the ledger can be reflected in all copies within minutes or seconds. The assets includes financial, legal, physical and electronic. But, portability of a blockchain process with other non-block chain processes is a challenging task. The conventional methods are not able to provide coexistence of the blockchain with the non-block chain systems.

Thus, solutions or platforms that enable communication between multiple blockchain deployments to co-exist and interoperate between them will be appreciated.

### SUMMARY

Embodiments of the present disclosure provides technological improvements as solutions to one or more of the above-mentioned technical problems recognized by the inventors in conventional systems. For example, in one embodiment, a method and system providing a gateway framework that enables coexistence between a blockchain ecosystem and a non-blockchain ecosystem.

In one embodiment, a processor-implemented method for coexistence between a blockchain ecosystem and a non-blockchain ecosystem. Wherein the non-blockchain ecosystem comprise of at least one of a traditional messaging network. Herein, the method comprising one or more steps of receiving a set of business processes, protocol and a message format of the non-blockchain ecosystem, generating a smart contract from the received set of business processes of the non-blockchain ecosystem, analyzing a smart contract of the blockchain ecosystem and the received protocol and the message format of the non-blockchain ecosystem to transmit at least one transaction, invoking at least one distributed ledger application programming interface (DLAPI) based on the analysis of the smart contract of the blockchain ecosystem and the protocol and the message format of the non-blockchain ecosystem, and transmitting the at least one transaction between the blockchain ecosystem and the non-blockchain ecosystem using the invoked at least one distributed ledger application programming interface (DLAPI).

In another embodiment, a system is configured to provide coexistence between a blockchain ecosystem and a non-blockchain ecosystem. The system comprising at least one memory storing a plurality of instructions and one or more hardware processors communicatively coupled with the at least one memory. The one or more hardware processors are configured to execute one or more modules comprises of a receiving module, a generating module, an analyzing module, an invocation module, and a transmitting module. The receiving module of the system is configured to receive a set of business processes, protocol and a message format of the non-blockchain ecosystem, the generating module configured to generate a smart contract from the received set of business processes of the non-blockchain ecosystem, the analyzing module configured to analyze a smart contract of the blockchain ecosystem and the received protocol and the message format of the non-blockchain ecosystem to transmit at least one transaction, an invocation module configured to invoke at least one distributed ledger application programming interface (DLAPI) based on the analysis of the smart contract of the blockchain ecosystem 2.0 and the protocol and the message format of the non-blockchain ecosystem, and the transmitting module configured to transmit the at least one transaction between the blockchain ecosystem and the non-blockchain ecosystem using the invoked at least one distributed ledger application programming interface (DLAPI).

In yet another embodiment, a non-transitory computer readable medium storing one or more instructions which when executed by a processor on a system, cause the processor to perform method. A processor-implemented method for coexistence between a blockchain ecosystem and a non-blockchain ecosystem. Wherein, the non-blockchain ecosystem comprise of at least one of a traditional messaging network. Herein, the method comprising one or more steps of receiving a set of business processes, protocol and a message format of the non-blockchain ecosystem, generating a smart contract from the received set of business processes of the non-blockchain ecosystem, analyzing a smart contract of the blockchain ecosystem and the received protocol and the message format of the non-blockchain ecosystem to transmit at least one transaction, invoking at least one distributed ledger application programming interface (DLAPI) based on the analysis of the smart contract of the blockchain ecosystem and the protocol and the message format of the non-blockchain ecosystem, and transmitting the at least one transaction between the blockchain ecosystem and the non-blockchain ecosystem using the invoked at least one distributed ledger application programming interface (DLAPI).

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates a networking environment implementing blockchain coexistence, in accordance with an embodiment of the present subject matter;

FIG. 2 illustrates a block diagram of a system for blockchain coexistence, in accordance with an example embodiment;

FIG. 3 illustrates an example architecture diagram for the blockchain coexistence, in accordance with an example embodiment;

FIG. 4 illustrates an example block diagram for a gateway framework, in accordance with an example embodiment; and

FIG. 5 illustrates a flowchart for a blockchain coexistence, in accordance with an example embodiment.

It should be appreciated by those skilled in the art that any block diagrams herein represent conceptual views of illustrative systems and devices embodying the principles of the present subject matter, Similarly, it will be appreciated that any flow charts, flow diagrams, and the like represent various processes which may be substantially represented in computer readable medium and so executed by a computer or processor, whether or not such computer or processor is explicitly shown.

### DETAILED DESCRIPTION OF EMBODIMENTS

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments, It is intended that the following detailed description be considered as exemplary only, with the true scope and spirit being indicated by the following claims.

The embodiments herein provide a method and a system for blockchain coexistence between a blockchain ecosystem and a non-blockchain ecosystem. It would be appreciated that the system described herein, alternatively referred as a gateway which enables a communication between any existing system and blockchain ecosystem thereby establishing coexistence between them. It is to be appreciated that a blockchain platform is alternatively referred as a Distributed Ledger (DL) platform.

It would be appreciated that the system is configured to connect a blockchain solution with at least one existing application by utilizing the gateway framework. The gateway framework includes a gateway and information on a set of smart solutions. The gateway incudes a simple Java APIs (Application Programming Interfaces) on one side for the existing systems or the traditional applications to connect to the blockchain APIs on the other side for connecting with the different block chain technologies.

Referring now to the drawings, and more particularly to FIG.

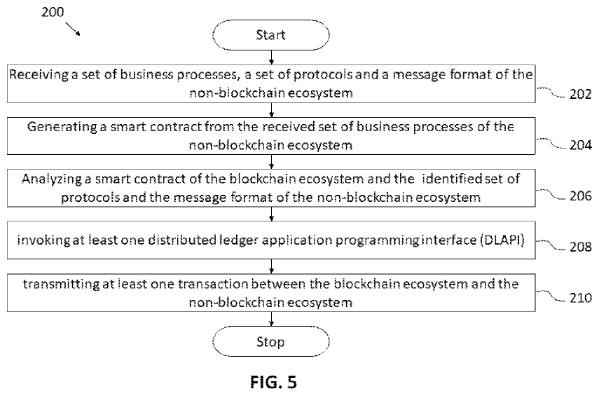

1 through FIG. 5, where similar reference characters denote corresponding features consistently throughout the figures, there are shown preferred embodiments and these embodiments are described in the context of the following exemplary system and/or method.

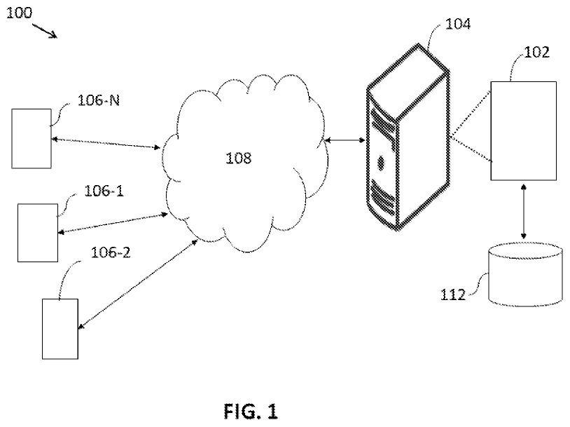

FIG. 1 illustrates a blockchain environment (100) wherein a system (102) for blockchain coexistence between one blockchain ecosystem and a non-blockchain ecosystem, according to some embodiments of the present disclosure. The system (102) is configured to implement a gateway framework. The system (102) may be embodied in a computing device, for instance a computing device (104).

Although the present disclosure is explained considering that the system (102) is implemented on a server, it may be understood that the system (102) may also be implemented in a variety of computing systems, such as a laptop computer, a desktop computer, a notebook, a workstation, a cloud-based computing environment and the like. In one implementation, the system (102) may be implemented in a cloud-based environment. It will be understood that the system (102) may be accessed by multiple users through one or more user devices 106-1, 106-2 . . . 106-N, collectively referred to as user devices (106) hereinafter, or applications residing on the user devices (106). Examples of the user devices (106) may include, but are not limited to, a portable computer, a personal digital assistant, a handheld device, a smartphone, a tablet computer, a workstation and the like. The user devices (106) are communicatively coupled to the system (102) through a network (108).

In an embodiment, the network (108) may be a wireless or a wired network, or a combination thereof. In an example, the network (108) can be implemented as a computer network, as one of the different types of networks, such as virtual private network (VPN), intranet, local area network (LAN), wide area network (WAN), the internet, and such. The network (106) may either be a dedicated network or a shared network, which represents an association of the different types of networks that use a variety of protocols, for example, Hypertext Transfer Protocol (HTTP), Transmission Control Protocol/Internet Protocol (TCP/IP), and Wireless Application Protocol (WAP), to communicate with each other. Further, the network (108) may include a variety of network devices, including routers, bridges, servers, computing devices, storage devices. The network devices within the network (108) may interact with the system (102) through communication links.

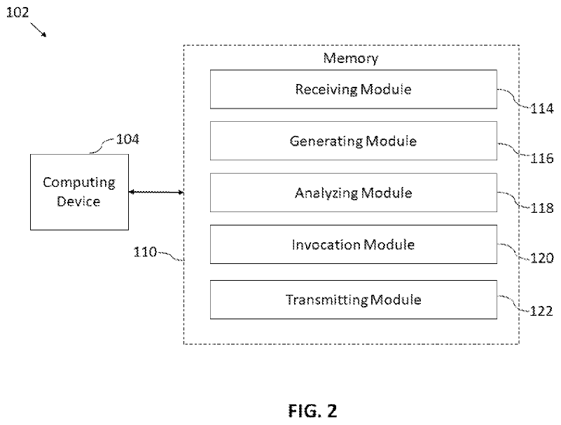

As discussed above, the system (102) may be implemented in a computing device (104), such as a hand-held device, a laptop or other portable computer, a tablet computer, a mobile phone, a PDA, a smartphone, and a desktop computer. The system (102) may also be implemented in a workstation, a mainframe computer, a server, and a network server. In an embodiment, the system (102) may be coupled to a data repository, for example, a repository (112). The repository (112) may store data processed, received, and generated by the system (102). In an alternate embodiment, the system (102) may include the data repository (112). The components and functionalities of the system (102) are described further in detail with reference to FIG. 2.

Referring FIG. 2, the system (102) further comprising a receiving module (114), a generating module (116), an analyzing module (118), an invocation module (120), and a transmitting module (122). It is to be that the system (102) described herein, alternatively referred as a gateway which enables a communication between any existing system and blockchain ecosystem thereby establishing coexistence between them.

In the preferred embodiment, the receiving module (114) of the system (102) is configured to receive a set of business processes, a set of protocols and a message format of the non-blockchain ecosystem.

In the preferred embodiment, the generating module (116) of the system (102) is configured to generate a smart contract from the received set of business processes of the non-blockchain ecosystem. It would be appreciated that the traditional applications are associated with a database and they may be communicated by utilizing simple APIs only because they are independent of different underlying native distributed ledger application programming interface (DLAPI).

In the preferred embodiment, the analyzing module (118) of the system (102) is configured to analyze a smart contract of the blockchain ecosystem and the received set of protocols and the message format of the non-blockchain ecosystem to transmit at least one transaction. It would be appreciated that a set of smart solutions of the blockchain includes a set of smart contracts, a set of status transitions, digital signature, journal and audit, a set of pluggable software components. In a blockchain solution, a set of new data blocks are appended to the distributed ledger and based on business requirements, a set of states associated with the transaction is maintained. Further, the set of status transitions can be performed as a new transaction, appending one more block in the chain. Further, the blockchain provides cryptography based security aspects. Additionally, the blockchain solution includes additional security layers including signatures to validate the identity of a user. Furthermore, each blockchain transaction is audited by the solution and complete journal and audit trail of the traditional application is maintained.

In an alternate embodiment, the pluggable software components are an extension to enable applications to call a Quartz Gateway. Here, a data conversion from Java Script Object Notation (JSON) source and Business Plain Old Java Object (POJO) can be done based on mapping XML. Additionally, the data conversion from Business POJO to JSON can be performed. The signature of the API can be a JSON object. In the Quartz Gateway, JSON object includes a header, a payload and an access policy. Further, the Quartz Gateway is capable of eliminating a need for large scale changes to be done in the existing applications to adapt to multiple technologies.

In the preferred embodiment, the invocation module (120) of the system (102) is configured to invoke at least one distributed ledger application programming interface (DLAPI) based on the analysis of the smart contract of the blockchain ecosystem and the set of protocols and the message format of the non-blockchain ecosystem. The DLAPI is associated with an API Catalogue including a list of API for a plurality of applications. It is to be noted that the DLAPI invokes a distributed ledger

(DL) Controller to access a distributed ledger (DL) Processor to get details from a distributed ledger (DL) Platform. The DL Platform has a service id and subscription details. Further, the system (102) is capable of publishing a set of APIs for business use cases that are realized in DL platform.

In the preferred embodiment, the transmitting module (122) of the system (102) is configured to transmit the at least one transaction between the blockchain ecosystem and the non-blockchain ecosystem using the invoked at least one distributed ledger application programming interface (DLAPI). It would be appreciated that the system (102) configured to perform a set of transactions including Distributed Ledger Business Transaction (DLBT) and Distributed Ledger Enquiry Transaction (DLET), The DLBT includes creating and updating business data by utilizing the Quartz Gateway. The DLET includes creating and updating query business data by utilizing the Quartz Gateway. In an embodiment, the DLG provides information in single or bulk and have the API signature along with JSON schema for consumption. Additionally, the Quartz Gateway can handle multiple DL platform protocols with the help of DL Specific adapters.

In another embodiment, the system (102) is configured for blockchain coexistence is capable of: (i) concurrent Adoption of block chain (ii) enabling blockchain friendly processes to be ported on to block chain technology (iii) reusing of the existing applications or processes where relevant and enabling co existing with block chain solution iv) providing a connectivity solution for easier Integration and v) De risking and simplifying block chain adoption.

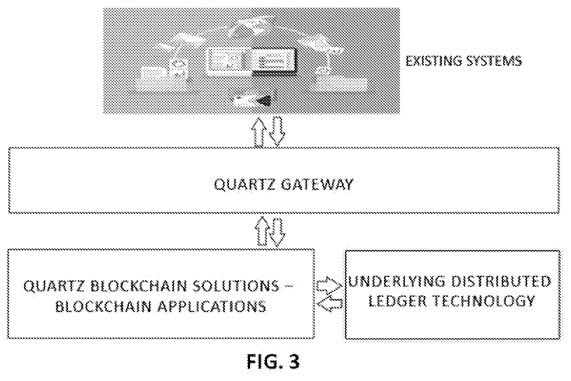

FIG. 3 illustrates an example block diagram for the blockchain coexistence architecture, in accordance with an example embodiment. Now referring to FIG. 3, the block diagram includes a set of blockchain solutions, a gateway and a set of non-blockchain systems. The set of blockchain solutions work on a blockchain. The set of non-blockchain systems are associated with a database. The Quartz Gateway enables the integration of the non-blockchain systems with the blockchain solutions. In an embodiment, the Quartz Gateway includes a standard Java Rest Application Programming Interfaces (APIs) to connect with the set of non-blockchain systems. Further, the gateway includes a distributed ledger APIs to connect to the set of blockchain solutions based on an underlying block chain technology. Here, the set of non-block chain systems can communicate by utilizing simple APIs and are independent of different underlying native DL technology APIs. Additionally, the present disclosure can connect with the underlying distributed ledger (DL) technology by utilizing the corresponding native APIs to provide co-existence and integration.

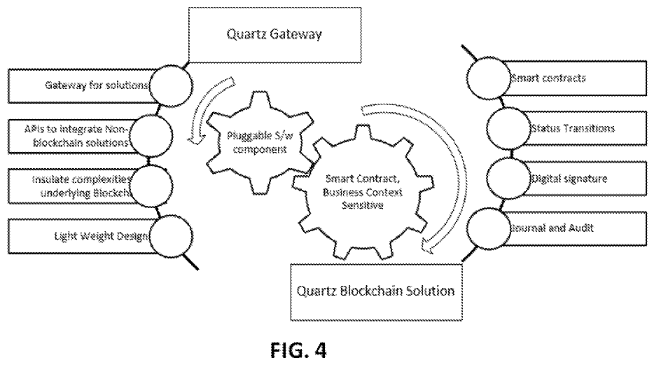

FIG. 4 illustrates an example block diagram for a gateway framework, in accordance with an example embodiment. Now referring to FIG. 4, the gateway framework includes a Quartz Gateway and a set of smart solutions. The Quartz Gateway incudes a simple Java APIs (Application Programming Interfaces) on one side for the traditional applications to connect to the blockchain APIs on the other side for connecting with the different blockchain technologies.

Referring FIG. 5, wherein the processor-implemented method (102) for blockchain coexistence between two or more independent ecosystems. The method comprises one or more steps for the blockchain coexistence.

Initially, at the step (202), a set of business processes, protocol and a message format of the non-blockchain ecosystem are received at a receiving module (114) of the system (102).

In the preferred embodiment, at the step (204) a smart contract is generated at a generating module (116) of the system (102) from the received set of business processes of the non-blockchain ecosystem.

In the preferred embodiment, at the step (206) a smart contract of the blockchain ecosystem and the received set of protocols and the message format of the non-blockchain ecosystem are analyzed at an analyzing module (118) of the system (102) to transmit at least one transaction.

In the preferred embodiment, at the step (208), at least one distributed ledger application programming interface (DLAPI) is invoked at an invocation module (120) of the system (102) based on the analysis of the smart contract of the blockchain ecosystem and the set of protocols and the message format of the non-blockchain ecosystem. Further, it would be appreciated that the DLAPI is invoked to integrate one or more applications of the non-blockchain ecosystem. Additionally herein, the DLAPI is associated with an API Catalogue comprising a list of API for the one or more application of the non-blockchain ecosystem

Finally, at the last step (210), at least one transaction is transmitted between the blockchain ecosystem and the non-blockchain ecosystem at a transmitting module (122) of the system (102) using the invoked at least one distributed ledger application programming interface (DLAPI).

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments of present disclosure herein addresses unresolved problem of blockchain coexistence.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g. any kind of computer like a server or a personal computer, or the like, or any combination thereof. The device may also include means which could be e.g, hardware means like e.g. an application-specific integrated circuit (ASIC), a field-programmable gate array (FPGA), or a combination of hardware and software means, e.g. an ASIC and an FPGA, or at least one microprocessor and at least one memory with software modules located therein. Thus, the means can include both hardware means and software means. The method embodiments described herein could be implemented in hardware and software. The device may also include software means. Alternatively, the embodiments may be implemented on different hardware devices, e.g. using a plurality of CPUs.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to 2.0 only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

1. A system configured for coexistence of a blockchain ecosystem non-blockchain ecosystem, the system comprising:
at least one memory storing a plurality of instructions;
one or more hardware processors communicatively coupled with the at least one memory, wherein the one or more hardware processors are configured to execute one or more modules;
a receiving module configured to receive a set of business processes, protocol and the message format of the non-blockchain ecosystem;
a generating module configured to generate a smart contract from the received set of business processes of the non-blockchain ecosystem;
an analyzing module configured to analyze a smart contract of the blockchain ecosystem and the identified protocol and message format of the non-blockchain ecosystem for at least one transaction;
an invocation module configured to invoke at least one distributed ledger application programming interface (DLAPI) based on the analysis of the smart contract of the blockchain ecosystem and the protocol and message format of the non-blockchain ecosystem; and
a transmitting module configured to transmit at least one transaction between the blockchain ecosystem and the non-blockchain ecosystem using the invocation of at least one distributed ledger application programming interface (DLAPI).

2. The system claimed in claim 1, wherein the DLAPI is invoked to integrate one or more application of the non-blockchain ecosystem.

3. The system claimed in claim 1, wherein the DLAPI is associated with an API Catalogue comprising a list of API for the one or more application of the non-blockchain ecosystem.

4. The system claimed in claim 1, wherein the at least one transaction comprising a Distributed Ledger Business Transaction (DLBT) and a Distributed Ledger Enquiry Transaction (DLET).

5. A processor-implemented method for coexistence of a blockchain ecosystem with a non-blockchain ecosystem, the method comprising one or more steps of:
receiving, via one or more hardware processors, a-13 set of business processes, a set of protocols and a message format of the non-blockchain ecosystem for coexistence with the blockchain ecosystem;
generating, via one or more hardware processors, a smart contract from the received set of business processes of the non-blockchain ecosystem;
analyzing, via one or more hardware processors, a smart contract of the blockchain ecosystem and the identified set of protocols and the message format of the non-blockchain ecosystem for the transaction;
invoking, via one or more hardware processor at least one distributed ledger application programming interface (DLAPI) based on the analysis of the smart contract of the blockchain ecosystem and the set of protocols and the message format of the non-blockchain ecosystem; and
transmitting, via one or more hardware processors, at least one transaction between the blockchain ecosystem and the non-blockchain ecosystem using the invocation of at least one distributed ledger application programming interface (DLAPI).

6. The method claimed in claim 5, wherein the DLAPI is invoked to integrate one or more application of the non-blockchain ecosystem.

7. The method claimed in claim 5, wherein the DLAPI is associated with an API Catalogue comprising a list of API for the one or more application of the non-blockchain ecosystem.

8. The method claimed in claim 5, wherein the at least one transaction comprising a Distributed Ledger Business Transaction (DLBT) and a Distributed Ledger Enquiry Transaction (DLET).

9. A non-transitory computer readable medium storing one or more instructions which when executed by a processor on a system, cause the processor to perform method comprising:
receiving, via one or more hardware processors, a set of business processes, a set of protocols and a message format of the non-blockchain ecosystem for coexistence with the blockchain ecosystem;
generating, via one or more hardware processors, a smart contract from the received set of business processes of the non-blockchain ecosystem;
analyzing, via one or more hardware processors, a smart contract of the blockchain ecosystem and the identified set of protocols and the message format of the non-blockchain ecosystem for the transaction;
invoking, via one or more hardware processors, at least one distributed ledger application programming interface (DLAPI) based on the analysis of the smart contract of the blockchain ecosystem and the set of protocols and the message format of the non-blockchain ecosystem; and
transmitting, via one or more hardware processors, at least one transaction between the blockchain ecosystem and the non-blockchain ecosystem using the invocation of at least one distributed ledger application programming interface (DLAPI).
